(19) United States
(12) Patent Application Publication
(10) Pub. No.: US 2014/0143295 A1
(43) Pub. Date: May 22, 2014

(54) FRAMEWORK FOR CROSS-PLATFORM COLLABORATION OF ACTIVITIES

(71) Applicants: Charles Girsch, Denver, CO (US); Maria Girsch, Denver, CO (US)

(72) Inventors: Charles Girsch, Denver, CO (US); Maria Girsch, Denver, CO (US)

(21) Appl. No.: 14/085,482

(22) Filed: Nov. 20, 2013

Related U.S. Application Data
(60) Provisional application No. 61/728,537, filed on Nov. 20, 2012.

(51) Int. Cl. H04L 29/08

(52) U.S. Cl. CPC H04L 67/10
USPC 709/202

(57) ABSTRACT

A method for synchronizing applications may include authenticating a first user based on receiving an authentication function call from an application running on a first computing device. An invitation request may be transmitted to a second computing device to join the application. A session identification may be transmitted to the first computing device and second computing device. An event post function call may be received from the first computing device, the event post function call including a change to the application. An event fetch function call may be received from the second computing device and based on the receiving the change to the application may be transmitted to the second computing device.

### CROSS-REFERENCE TO RELATED PATENT DOCUMENTS

This patent application claims the benefit of priority, under 35 U.S.C. §119(e), to U.S. Provisional Patent Application Ser. No. 61/728,537, titled “FRAMEWORK FOR CROSS-PLATFORM COLLABORATION OF ACTIVITIES,” filed on Nov. 20, 2012, which is incorporated by reference in its entirety. This patent application is also related to application Ser. No. 12/618,671, titled “SYSTEMS AND METHODS FOR INTERACTIVE READING,” filed Nov. 13, 2009, incorporated by reference in its entirety.

### BACKGROUND

Users increasingly have a diverse range of computing devices and platforms from which to interact with other users. For example, a user may have a mobile phone that is associated with a specific operating system from which games may be played with other users that have a mobile phone running the same operating system. Additionally, the user may run a game on a personal computer in which they play against other users that are executing the same game on their respective personal computers.

### BRIEF DESCRIPTION OF DRAWINGS

Some embodiments are illustrated by way of example and not limitation in the figures of the accompanying drawings in which:

FIG. 1 is a network system diagram, according to various example embodiments.

FIG. 2 is a flow diagram, according to various example embodiments.

FIG. 3 is a flow chart illustrating a method, according to various example embodiments.

FIG. 4 is a block diagram of machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

As computers and devices have become more connected, using software is something no longer done by one person alone in isolation. From games to business apps, users want to collaborate, educate, and entertain together. While software was at one time viewed as something that separates people, it is now part of a new social fabric and tool for communication.

Previously, developers may have had to create infrastructure from scratch to support social/multi-user experience. In some cases, developers had to write low-level networking code to facilitate communication between their applications. The Internet further complicated this infrastructure; including typically set up their own servers to provide an Internet-capable infrastructure for their applications. As the number of users wanting these real-time shared experiences grew, software companies found themselves establishing many servers for each program/game/application they offered. The maintenance and hardware infrastructure very quickly became a management burden.

To simplify development of multiplayer/multi-user applications, some platform vendors began to offer this infrastructure as a set of services that could be used by developers. Of course, each vendor chose to create their own proprietary set of services making play/interaction across platforms impossible and/or difficult.

The following disclosure provide descriptions of a foundation of services (referred to as “Collaboration Foundation” services “or “CF”) that may be used to create applications that provide real-time synchronous gameplay and/or application data communication across diverse platforms. For example, the services provided by the CF include services to add multiplayer/multi-user functionality to an application, including, but not limited to: User Authentication; User with Friends and Circle Concepts; Session/Game Instance; NAT safe/Internet-friendly packet communications; and Integrated VoIP for all session participants.

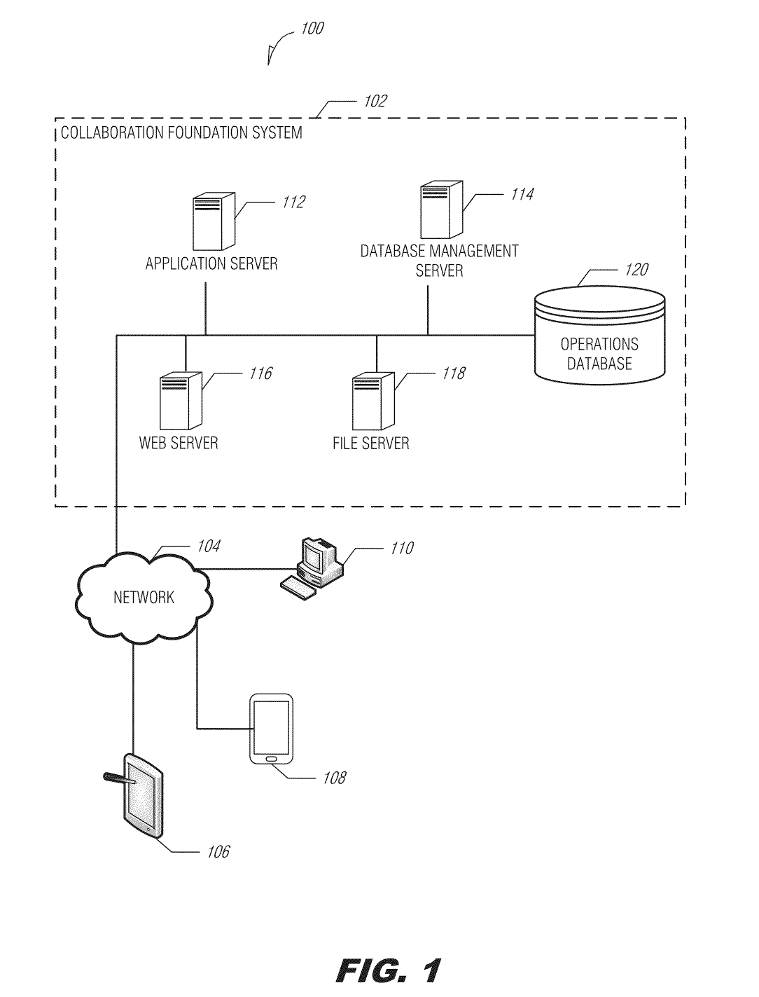

FIG. 1 illustrates a network system diagram 100, according to various example embodiments. Diagram 100 includes, Collaboration Foundation System 102 (CFS), network 104, user terminals 106, 108, 110, application server 112, database management server 114, web server 116, file server 118, and operations database 120.

In various examples, CFS 102 is illustrated as including four separate servers, however, functionality of these servers may be combined into one server or additional servers. Furthermore, the term server is not limited to a single physical location or machine (e.g., multiple virtual machines running servers may exist on one physical machine). Similarly, operations database 120 may be separate or combined with the servers.

User terminals 106, 108, and 110 are computing devices that may run applications that utilize services provided by CFS 102 For example, user terminal 110 may be a personal computer, whereas user terminal 106 may be a tablet based computing device, and user terminal 108 may be a mobile phone. User terminals 104, 106, and 108 may each run the same operating system, different operating systems, or a combination of operating system.

In various examples, a client program or application is executed on user terminals 106, 108, and 110 that utilizes services provided by CFS 102. The client program may include commercial software, custom software, open source software, freeware, shareware, or other types of software packages. In an embodiment, the client program includes a thin client front end for accessing the application (e.g., a web browser). While not illustrated, user terminals 104, 106, and 108 may also communicate with a web server associated with the client program.

Network 104 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. Network 104 may include a single local area network (LAN) or wide-area network (WAN), or combinations of LAN's or WAN's, such as the Internet. The various devices coupled to network 104 may be coupled to network 104 via one or more wired or wireless connections.

Servers 112-118 and operations database 120 may work together to provide functionality requested by client programs running on the user terminals. For example, web server 116 may receive function calls provided via an API of CFS 102. Web server 116 may communicate with file server 118 to publish or serve files stored on file server 118. Web server 108 may also communicate or interface with the application server 112 to enable web-based presentation of information. For example, application server 112 may consist of scripts, applications, or library files that provide primary or auxiliary functionality to web server 108 (e.g., multimedia, file transfer, or dynamic interface functions).

Operations database 120 may be composed of one or more logical or physical databases. For example, operations database 120 may be viewed as a system of databases that when viewed as a compilation, represent an “operations database.” Sub-databases in such a configuration may include a user database, session database, and device databases utilized in providing the services of CFS 102. Accessing, updating, modifying data stored in operations database 120 may be performed by database management server 114. Operations database 120 may be implemented as a relational database, a centralized database, a distributed database, an object oriented database, or a flat database in various embodiments.

In various example, services of the Collaboration Foundation are provided to developers via a JavaScript Object Notation (JSON)/Representational State Transfer (REST) web services API, however other API paradigms may also be used. In an example, no socket programming or low-level network code is required. Using the Collaboration Foundation may provide developers a considerable head start for a real-time social application experience.

In various examples, a software development kit (SDK) is provided for use with the Collaboration Foundation's API. Many different game engines or frameworks may be used with the SDK. In other words, calls to the CF may be made using an existing application. In an example, for game engines or frameworks that allow web service calls, the CF may be integrated directly via the JSON/REST interface. Many different operation systems and hardware platforms may use the Collaboration Framework, including, but not limited to iOS® ANDROID®, HTML5, ADOBE FLASH®, MICROSOFT® platforms. VOIP and video communication services may be initiated and established via CF service calls.

In various examples, the CF uses a web services model. This may provide flexibility for integration and broad platform support. In an example, standard Internet ports (80/443) are used leading to the core services working across public WiFi hotspots without potential security hassles. The following descriptions discuss concepts of the CF system as well as function calls (e.g., web services) that the CF system provides. Example code is also provided for the various services.

In various examples, the web services constitute the communications protocol for the CF. The following descriptions identify the concepts behind the services, their implementation, and usage for developers. In an example, the CF implements a connectionless model for network communication using a set of web services. One benefit of this approach is the simplicity and reliability over mobile Internet connections.

In various example, the concept of a User ID is the unique identifier for a CF user that is used in service requests and actions upon the user. In an various example, a User ID created at time of time of user creation. is an effective primary key for user information, and is a globally unique ID for the user. In various examples, a user is a user of an application running on a user terminal.

In various examples, a security token is utilized in the CF system. For example, services used within the CF system may contain a security token created as part of the users authentication process. In an example, these tokens expire when not used. In various examples token generation is random, a token is created upon successful login and identifies user, and a token is automatically invalidated after a period of inactivity.

In various examples Device IDs are utilized in the CF system that is a unique identifier for every device that a user may utilize. This unique identifier may be used to give context to the user and permits a scenario where a user may be logged in at multiple devices. In various examples, Device IDs are created when the user first logs in to the device (e.g., user terminal), is globally unique ID for the device, and includes descriptive platform information (e.g., operating system, capabilities, screen size, etc.).

In various examples, Session IDs are utilized in the CF system. For example, users may create/join sessions identified by a Session ID to engage in activities. A session may persist beyond the application allowing users to stay together as they play and enjoy activities. A Session ID may be created when a user invites another user. In an example, the user that creates the session is the session owner and has the ability to end the session (e.g., when the session owner leaves the application).

In various examples, a session is comprised of one or more users. Additionally, information used to synchronize play during an activity is done in the context of a session. Each session may have associated User IDs and a single session owner. In an example, when the session owner changes activities, other users are brought to that new activity (providing they have access to that activity). In various example, activities may be aspects of an application (e.g., reading a book, playing a game, changing focus of the application).

In various examples, the CF system includes four service categories: (1) Authentication; (2) User; (3) Session; and (4) Packet. Various function calls associated with these categories are listed below. Communication channels may also be established using the CF system (e.g., VOIP, video of the users). Further detail of these function calls (e.g., web services) are detailed in this disclosure. The names of the function calls and services are for example purposes and other labels may be used without departing from the scope of this disclosure.

In various example, the authentication category is associated with authentication services. In an example, prior to invoking any of the CF services, an authentication token is be created. This token is generated by a request to the login service. Services associated with the authentication category may include AuthLogin and AuthLogout.

In various examples, the user category defines the services for user information and management. In an example, data provided by these services is persisted within a database backend (e.g., database management server 114 and operations database 120). User services may include UserInfo, UserList, and CircleManager.

In various examples, users create a session through invitation and the session is created when a user is invited. Services for the session category may include Invite, AckInvite, ChangeApp, AckChangeApp, Kick, and End.

In various examples, packets in the CF system may be used to exchange application synchronization information between users within a session. Packets may contain text and graphic content for synchronization. Services in the packets category may include Post, Fetch, and Flush.

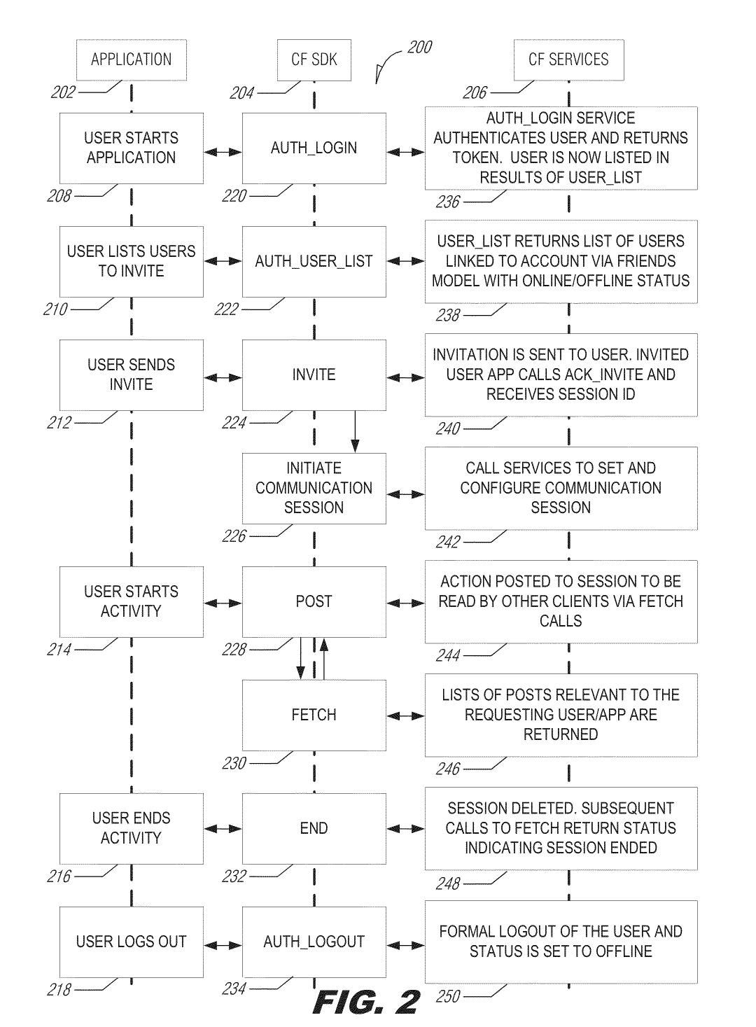

In various examples, the following description is an application lifecycle utilizing the CF system. FIG. 2 is an example flow diagram 200 that illustrates the lifecycle via application 202, CF SDK calls 204, and CF services 206 (e.g., provided by CFS 102).

In an example, the lifecycle may begin with a user starting an application that utilizes the CF system on a user device (208). The user login may take place interactively or automatically via call to AuthLogin (220). AuthLogin may authenticate the user and return a token for subsequent service calls (236).

In an example, the application invokes UserList to produce a list of available friends for the user (210, 222, and 238). The user may then invite a another user using Invite and a session is returned (212, 224, and 240). The application may then wait until the invite is accepted by the user via AckInvite (240).

A communication channel may also be established between the two users (e.g., VoIP and/or video) so that the users may communicate with each other while using the application (226 and 228). In an example, a third party provider is used for the communications.

In an example, the session ID is then used to begin posing of application specific messages via Post (214, 228, and 244). These messages may be received by each user via Fetch (230, and 246). The session may be ended via a call to End initiated by a user ending an activity (216, 232, and 248). Upon a user logging out via AuthLogout the user may be set to offline (218, 234, and 250).

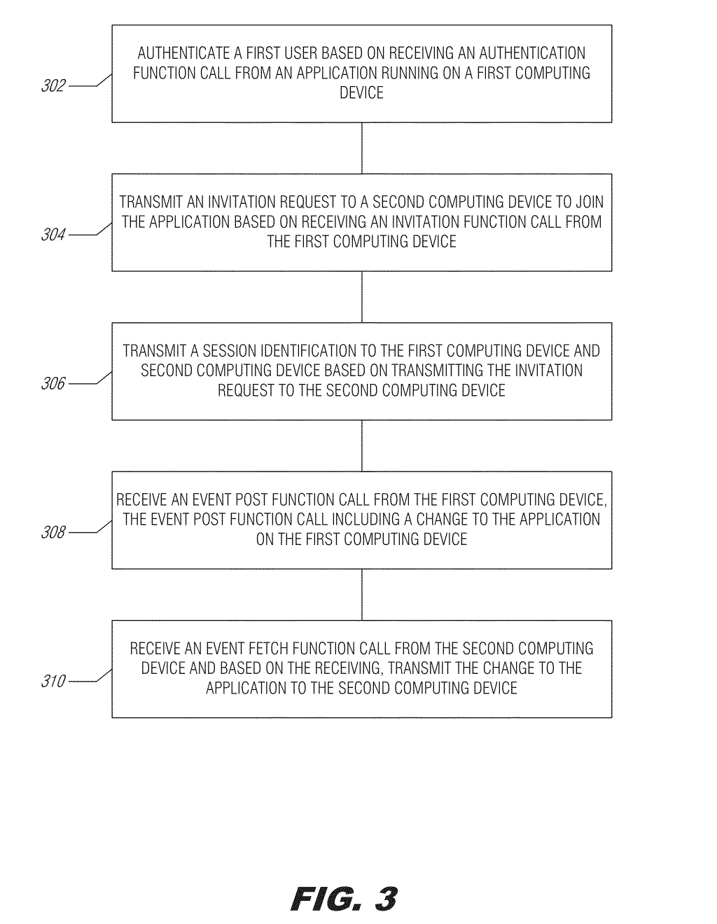

FIG. 3 illustrates an example flow chart of a method for processing API calls by CF supported applications. In an example, the operations of FIG. 3 are performed by a CFS such as depicted in FIG. 1. At block 302, in an example, a first user is authenticated based on receiving an authentication function call from an application running on a first computing device.

At block 304, in an example, an invitation request is transmitted to a second computing device to join the application based on receiving an invitation function call from the first computing device. For example, the first user may invite a second user or third user to interactively complete a puzzle. One of the users may be using a mobile phone while another user may be using an HTML 5 compliant web browser. One or more communication channels may be established between the first, second, and third users.

At block 306, in an example, a session identification may be transmitted to the first computing device and second computing device based on transmitting the invitation request to the second computing device. The session id may be stored at the CFS for use in determining which messages are transmitted to which computing devices.

At block 308, in an example, an event post function call is received from the first computing device, the event post function call including a change to the application on the first computing device. For example, the event post function call may include a change to a puzzle piece or other change to the application that should be synchronized between computing devices. Similarly, post messages may be received from the second and third computing devices.

At block 310, in an example, an event fetch function call is received from the second computing device and based on this call, the change to the application may be transmitted to the second computing device. In an example, the change is transmitted to all computing devices associated with the session id. In an example, the change is transmitted to all computing devices associated with the session id except the computing device from which the post function call originated.

In an example the CFS delivers its functionality via web services utilizing REST/JSON application programming interfaces. The following descriptions provide detailed looks at the functionality of each service implementation and provides request/response formats for invoking these services. For each service, the description includes the following: category/service name, description, request parameters, response format, and implementation details.

In various examples, all services are be capable of producing a standardized error response as follows. These responses are consistent across all of the services. An application utilizing the CF should be capable of displaying these responses and handling such exceptions.

{

“error”:[{

“parameter”:<parameter (if applicable)>,
“message”: <Descriptive error message>,
“code”: <number identifying location of error>,
“subsystem”: <source of error>

},{

...repeated for multiple errors

}]

}

In an example, the AuthLogin authentication service authenticates a username and password combination, returning a temporary token valid for that specific device. The table below lists example request parameters.

| | |
|---|---|
| username | User name |
| password | Password |
| app | Current application name |
| appurl | URL for the application for install/download |
| deviceid | CFS Device identifier (blank for first time access) |
| deviceinfo | String containing user agent or device description |

An example response format is below.

```
{
      “token”: <temporary token for service calls>
      “deviceid”: <returns passed in deviceid or created id>
      “userinfo”: {
            “userid”: <CFS userid>,
            “username”: <username>,
            “fullname”: <User's full name>,
            “email”: <User email>,
            “status”: <User status online, offline>,
            “app”: <current application>,
            “appurl”: <URL for app>,
            “avatar”: <URL to image for avatar>
}
```

In an example, tokens are uniquely generated per device and maintained as a temporary CFS entry that will expire if not accessed. In an example, Deviceid is saved and persisted in the CFS if generated, Deviceinfo parameter contents may be used to update device information for that user and help with diagnosing platform specific issues, and Userinfo may be maintained within an mysql database. User status may be maintained by the CFS and if not found, status may set to offline.

In an example, the AuthLogout authentication service invalidates the current token. The table below lists example request parameters

| | |
|---|---|
| token | Token provided by the original AuthLogin |
| debug | Application specific data for the logout (ie. cause, |
| | etc) |

An example response format is below.

```
{
      “userid”: <CFS userid>,
      “token”: <temporary token for service calls>
      “deviceid”: <CFS deviceid>
}
```

In various examples, AuthLogout removes token entry from the CFS, invalidating users session. Entries (e.g., in a database) for user status in the CFS may also be removed.

In an example, the RegisterUser authentication service registers a new username and password combination, also collecting the user's full name and email address. When successful, the new user is automatically logged in and a temporary access token is granted and returned. In an example, user account can only be registered if the username and email address are unique. In an example, a successful registration will trigger an automatic login and the response will look identical to that of AuthLogin. The table below lists example request parameters.

| | |
|---|---|
| username | User name |
| password | Password |
| fullname | User's full name |
| email | User's email address |

An example response format is below.

```
{
      “token”: <temporary token for service calls>
      “deviceid”: <returns passed in deviceid or created id>
      “userinfo”: {
            “userid”: <CFS userid>,
            “username”: <username>,
            “fullname”: <User's full name>,
            “email”: <User email>,
            “status”: <User status online, offline>,
            “app”: <current application>,
            “appurl”: <URL for app>,
            “avatar”: <URL to image for avatar>
      }
}
```

In an example, the UserInfo user service returns information on one or more users as requested by the application. Multiple users may be specified via comma-separated list. The ability to access user info may be limited according privacy settings of the various computing devices. User info may be updated by specifying a properties list with the request. In an example, all fields aside from userid, app, appurl, and status are updateable through this method. The table below lists example request parameters

| | |
|---|---|
| token | Token provided by the original AuthLogin |
| user | Single username or comma-separated list of |
| | usernames |
| update | Property list for updating user info - only used on |
| | self |

An example response format is below.

```
{
      “userinfo”: [{
            “userid”: <CFSuserid>,
            “username”: <username>,
            “fullname”: <User's full name>,
            “email”: <User email>,
            “status”: <User status online, offline>,
            “app”: <current application>,
            “appurl”: <URL for app>,
            “avatar”: <URL to image for avatar>
      }, {
            ... additional user info for each user specified in request
      }]
}
```

In an example, the UserList user services supports a concept of named user lists. In an example, a list name may be “Friends,” but other lists may be used such as. banned/blocked users, family members, and groups. In an example, when specifying Add/Del, a username is specified. Regardless of action specified, the UserList call returns lists of users that currently comprise the specified list. In an example, invitations should only be sent to a member that is a member of a list. The table below lists example request parameters.

| | |
|---|---|
| token | Token provided by the original AuthLogin |
| listname | Friends (default), |
| action | List (default), Add, Del |
| username | Used with Add/Del actions (optional) |

An example response format is below.

```
{
      “circles”:[{
            “listname”:<Listname>,
            “userlistid”:<ListID>,
            “userinfo”: [{
                  “userid”: <CFS userid>,
                  “username”: <username>,
                  “fullname”: <User's full name>,
                  “email”: <User email>,
                  “status”: <User status online, offline>,
                  “app”: <current application>,
                  “appurl”: <URL for app>,
                  “avatar”: <URL to image for avatar>
            }, {
                  ... additional user info for each user specified in
                  request
            }],
      }, {
            ... additional info for each circle
      }]
}
```

In an example, the CircleManager user is associated with a concept of named user lists or circles. The CircleManager service provides support for adding/removing/listing circles. In an example, when specifying Add/Del, listname is specified and regardless of action specified, the service may always returns full set of circles. The table below lists example request parameters

| | |
|---|---|
| token | Token provided by the original AuthLogin |
| listname | Used with Add/Del actions (optional) |
| action | List (default), Add, Del |

An example response format is below.

```
{
  “circles”:[
    {
      “listname”:<name of the circle>,
      “userlistid”:<ID of the circle>
    },
    {
      ... additional info for other circles
    }
  ]
}
```

In an example, when the Invite session service is used a session is created upon issuing an invite to a user. In various example, users who join a session when ack'ing an invite via AckInvite. In an example, a user can only have one session at a time. All session information may be stored in the CFS may time out after inactivity. The End service may be used to clear out a session or reset invites. The table below lists example request parameters.

| | |
|---|---|
| token | Token provided by the original AuthLogin |
| userid | User to be invited (if blank, call will return status of |
| | invites) |

An example response format is below.

```
{
      “sessionid”:<sessionid>,
      “app”: <app name>,
      “owneruserid”: <userid of session owner>,
      “userinfo”: [{
            “userid”: <CFS userid>,
            “username”: <username>,
            “fullname”: <User's full name>,
            “email”: <User email>,
            “status”: <User status online, offline>,
            “app”: <current application>,
            “appurl”: <URL for app>,
            “avatar”: <URL to image for avatar>
            “invitestatus”: <response to status - Accepted, Waiting,
      Rejected, etc>,
            “invitemessage”: <provided from user app call to
            AckInvite>
      }, {
            ... additional user info for each user invited
      }]
}
```

In an example, the AckInvite session service allows a user to acknowledge an invite to a CFS session. Accepting an invite joins the session. An app or user may specify a message why they may or may not be able to join. Trigger for application managing an invite may be platform dependent (notification, email, etc), but app/user may be given session id for which to call this function. After AckInvite is posted, the app may begin Packet cycle (app specific). The table below lists example request parameters.

| | |
|---|---|
| token | Token provided by the original AuthLogin |
| sessionid | ID of session being invited to |
| invitestatus | Accept or Reject (if blank, call will return list of users) |
| invitemessage | Friendly message of acceptance or reason why they |
| | can't join (optional) |

An example response format is below.

```
{
      “sessionid”:<sessionid>,
      “app”: <app name>,
      “owneruserid”: <userid of session owner>,
      “userinfo”: [{
            “userid”: <CFS userid>,
            “username”: <username>,
            “fullname”: <User's full name>,
            “email”: <User email>,
            “status”: <User status online, offline>,
            “app”: <current application>,
            “appurl”: <URL for app>,
            “avatar”: <URL to image for avatar>
            “invitestatus”: <response to status - Accepted, Waiting,
      Rejected, etc>,
            “invitemessage”: <provided from user app call to
            AckInvite>
      }, {
            ... additional user info for each user in session
      }]
}
```

In an example, the ChangeApp session service allow users to change activities within a session. Like invites, this call may include a corresponding acknowledgement (AckChangeApp). In an example, ChangeApp serves primarily as an app independent mechanism to broadcast changes in current app and provide a URL to access that app. In an example, packet content reflects the app required for the data. The table below lists example request parameters.

| | |
|---|---|
| token | Token provided by the original AuthLogin |
| sessionid | ID of session |
| app | Qualified CFS app name |
| appurl | URL to download or install app (optional) |

An example response format is below.

```
{
      “sessionid”:<sessionid>,
      “app”: <app name>,
      “appurl”: <app URL>,
      “prevapp”: <app name of prior app>,
      “owneruserid”: <userid of session owner>
}
```

In an example, the ChangeAppAck session service enables an application to acknowledge an activity change in a friendly way. If a user does not have access to a given app, the acknowledge may be negative. By acknowledging with appstatus of ‘No’, a user may removed from the session and response is simply acknowledgement of request. In example, apps should call this in response to a ChangeApp action AND if the app changes in their Fetch response. The table below lists example request parameters.

| | |
|---|---|
| token | Token provided by the original AuthLogin |
| sessionid | ID of session |
| appstatus | Yes/No |
| appmessage | Message, eg. “User does not have app” (optional) |

An example response format is below.

```
{
      “sessionid”:<sessionid>,
      “app”: <app name>,
      “appurl”: <app URL>,
      “prevapp”: <app name of prior app>,
      “owneruserid”: <userid of session owner>
}
```

In an example, the Kick session service may be used to remove a user from a session. The Kick service provides this functionality as well as the ability to remove user from user list in one call. In an example the Kick server call provides one-shot interface via “hardkick” to remove user from list and force logout. The table below lists example request parameters.

| | |
|---|---|
| token | Token provided by the original AuthLogin |
| sessionid | ID of session |
| userid | ID of user to be kicked |
| hardkick | Yes/No (optional), if Yes, user is removed from |
| | owner list and logged out |

An example response format is below.

```
{
      “sessionid”:<sessionid>,
      “owneruserid”: <userid of session owner>,
      “hardkick”: <descriptive message of hardkick>
}
```

In an example, the End session service removes all relevant data from memcache and kicks all of the users out of the session. In an example, the session is then invalidated. The table below lists example request parameters.

| | |
|---|---|
| token | Token provided by the original AuthLogin |
| sessionid | ID of session |

An example response format is below.

```
{
      “sessionid”:<sessionid (now invalid)>,
      “owneruserid”: <userid of session owner>,
      “sessionstats”:{
            “start”:<dts of session start>,
            “end”: <dts of session end>,
            “total”: <total users>,
            “packets”:<total packets>,
            “debug”:<server filename if debug is enabled>
      }
}
```

In an example, the Post packet may be used by CFS apps to posts data to other apps within a session using the Post web service. The service is designed to push data and messages across the CFS to users associated with a session. In an example, the design is a low-level communications approach to enable interactivity across the widest spectrum of activities. In an example, response to a post is the equivalent of a default Fetch call saving a request/response cycle. This is the default behavior.

With reference to the request parameters, class may be used to allow the client to set a single value for that user. Class may be used for events that have a persistent value. For example, class could be “currentPlayerPosition” and a post would simply update that value. It acts as a replacement. Class may be used when multiple updates for something may occur between fetches. When no class is specified, events may post and accumulate for calls to Fetch. In various example, posted messages accumulate for the whole session. If the server is in debug mode, these messages may be dumped to a file upon the end of the session.

The table below lists example request parameters for Post.

| | |
|---|---|
| token | Token provided by the original AuthLogin |
| sessionid | ID of session |
| data | Data to be shared |
| datatype | txt - straight text (default), img - Base64 encoded |
| | image, bin - other Base64 encoded binary |
| class | None (default), class specifies a named value to be |
| | updated |
| message | Plain text message to accompany data, written to debug |
| autofetch | Yes (default), No - do an Fetch after posting |
| users | All (default), Single user or comma-separated list of |
| | users (future) |

An example response format is below.

```
{
      “sessionid”:<sessionid>,
      “owneruserid”: <userid of session owner>,
      “fetchdts”:<dts at time of packet fetch>,
      “usercount”:<number of users active in session>,
      “packet”:[{
            “userid”:<userid>,
            “app”: <app name>,
            “appurl”: <app url>,
            “dts”:<datetimestamp>,
            “data”,<data>,
            “datatype”,<datatype>,
            “class”:<class if applicable>
            “message”:<plain text message>
      }, {
            ...item for each packet returned
      }]
}
```

In an example, the Fetch packet service allows connected CFS apps to obtain a list of updates via the Fetch service. By default, the service may return all of the updates since the last fetch. This allows the service to return only the changes that have been posted.

In various example, class values that exist within the session will always be returned unless a dts is specified. In an example, only the most current class named values will be returned. Fetch requests may behave like a simulated stack. Aside from class entries, prior updates not included after they have been popped off. In an example, Peek flag allows requests that don't pop items off the virtual stack. Specifying All as the type may allow the virtualized stack to be replayed as it was built. In an example, all updates are included in the results (type of All should not be used in general application use, in various embodiements). In an example, if value of app changes, the client is responsible for acknowledging the app change via AckChangeApp.

The table below lists example request parameters.

| | |
|---|---|
| token | Token provided by the original AuthLogin |
| sessionid | ID of session |
| type | New (Default), All - all items, Classonly, specified |
| | dts - all after dts |
| peek | Yes, No (default) - next call to fetch returns the same |
| | set, don't pop items off of packet stack |
| app | All (Default), app name - filter by app. |
| users | All (default), Single user or comma-separated list of |
| | users (future) - filter by users |

An example response format is below.

```
{
      “sessionid”:<sessionid>,
      “owneruserid”: <userid of session owner>,
      “fetchdts”:<dts at time of packet fetch>,
      “usercount”:<number of users active in session>,
      “packet”:[{
            “userid”:<userid>,
            “app”: <app name>,
            “appurl”: <app URL>,
            “dts”:<datetimestamp>,
            “data”,<data>,
            “datatype”,<datatype>,
            “class”:<class if applicable>
            “message”:<plain text message>
      }, {
            ...item for each packet returned
      }
}
```

In an example, the Flush packet service removes all of the packets from the virtual stack of packet data. In an example, this function exists as a utility function to reset sessions contents. In an example, the function only returns items if autofetch is set to Yes. The function may remove packet entries for specific users and apps. The table below lists example request parameters.

| | |
|---|---|
| token | Token provided by the original AuthLogin |
| sessionid | ID of session |
| autofetch | Yes, No (default) - do an Fetch (ALL) after prior to |
| | flush |
| app | All (Default), app name - flush particular app. |
| users | All (default), Single user or comma-separated list of |
| | users (future) - flush particular user(s) |

An example response format is below.

```
{
      “sessionid”:<sessionid>,
      “owneruserid”: <userid of session owner>,
      “fetchdts”:<dts at time of packet fetch>,
      “usercount”:<number of users active in session>,
      “packet”:[{
            “userid”:<userid>,
            “app”: <app name>,
            “appurl”: <app URL>,
            “dts”:<datetimestamp>,
            “data”,<data>,
            “datatype”,<datatype>,
            “class”:<class if applicable>
            “message”:<plain text message>
      }, {
            ...item for each packet returned
      }
}
```

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

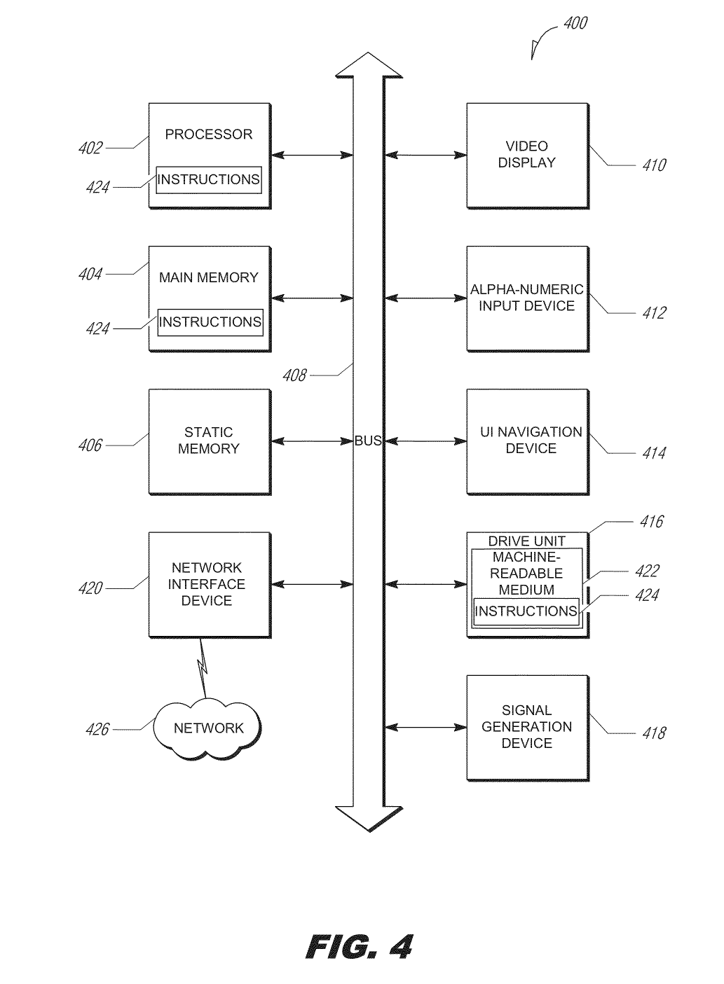

FIG. 4 is a block diagram of machine in the example form of a computer system 400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions and data structures (e.g., software) 424 embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although this disclosure includes reference to specific example embodiments, it will be evident that various modifications and changes may be made to these embodiments without departing from the broader spirit and scope of the invention (e.g., combining described embodiments/examples). Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the

[symbol]

What is claimed is:

1. A method comprising:
authenticating a first user based on receiving an authentication function call from an application running on a first computing device;
transmitting an invitation request to a second computing device to join the application based on receiving an invitation function call from the first computing device;
transmitting a session identification to the first computing device and second computing device based on transmitting the invitation request to the second computing device;
receiving an event post function call from the first computing device, the event post function call including a change to the application on the first computing device;
receiving an event fetch function call from the second computing device; and
based on receiving the event fetch function call, transmitting the change to the application to the second computing device.

2. The method of claim 1 further comprising:
initiating a communication channel between the first computing device and second computing device based on receiving an invitation acknowledgment from the second computing device.

3. The method of claim 1, wherein the communication channel is an audio channel.

4. The method of claim 1, further comprising:
receiving an event post function call from the second computing device, the event post function call including a change to the application on the second computing device;
receiving an event fetch function call from the second computing device; and
based on receiving the event fetch function call, transmitting the change to the application to the second computing device.

5. The method of claim 1, further comprising:
transmitting an invitation request to a third computing device to join the application based on receiving an invitation function call from the first computing device;
transmitting a session identification to the third computing device based on receiving an invitation acknowledgement function call from the second computing device;
receiving an event fetch function call from the third computing device; and
based on receiving the event fetch function call from the third computing device, transmitting the change to the application to the third computing device.

6. The method of claim 5, wherein the first computing device, second computing device, and third computing device have different operating systems.

7. The method of claim 1, further comprising:
receiving an indication that the application has ended on the first computing device;
receiving a subsequent event fetch call from the second computing device; and
based on the receiving the indication and subsequent event fetch call, transmitting a status to the second computing device indicating the application is ended.

8. The method of claim 1, wherein the change to the application is a movement of a graphical user interface element of the application.

9. The method of claim 1, further comprising:
retrieving a plurality of changes to the application based on the session identification; and
transmitting the plurality of changes to computing devices associated with the session identification.

10. A system comprising:
at least one processor;
a storage device with instructions stored thereon, wherein the at least one processor is configured to execute the instructions to perform operations comprising:
authenticating a first user based on receiving an authentication function call from an application running on a first computing device;
transmitting an invitation request to a second computing device to join the application based on receiving an invitation function call from the first computing device;
transmitting a session identification to the first computing device and second computing device based on transmitting the invitation request to the second computing device;
receiving an event post function call from the first computing device, the event post function call including a change to the application on the first computing device;
receiving an event fetch function call from the second computing device; and
based on receiving the event fetch function call, transmitting the change to the application to the second computing device.

11. The system of claim 10, wherein the operations further comprise:
initiating a communication channel between the first computing device and second computing device based on receiving an invitation acknowledgment from the second computing device.

12. The system of claim 10, wherein the communication channel is an audio channel.

13. The system of claim 10, wherein the operations further comprise:
receiving an event post function call from the second computing device, the event post function call including a change to the application on the second computing device;
receiving an event fetch function call from the second computing device; and
based on receiving the event fetch function call, transmitting the change to the application to the second computing device.

14. The system of claim 10, wherein the operations further comprise:
transmitting an invitation request to a third computing device to join the application based on receiving an invitation function call from the first computing device;
transmitting a session identification to the third computing device based on receiving an invitation acknowledgement function call from the second computing device;
receiving an event fetch function call from the third computing device; and
based on receiving the event fetch function call from the third computing device, transmitting the change to the application to the third computing device.

15. The system of claim 14, wherein the first computing device, second computing device, and third computing device have different operating systems.

16. The system of claim 10, wherein the operations further comprise:
receiving an indication that the application has ended on the first computing device;
receiving a subsequent event fetch call from the second computing device; and
based on the receiving the indication and subsequent event fetch call, transmitting a status to the second computing device indicating the application is ended.

17. The system of claim 10, wherein the change to the application is a position of a player of the application.

18. The system of claim 10, wherein the operations further comprise:
retrieving a plurality of changes to the application based on the session identification; and
transmitting the plurality of changes to computing devices associated with the session identification.

19. A non-transitory computer-readable medium comprising instructions, which when executed by at least one processor, configure the at least one processor to perform operations comprising:
authenticating a first user based on receiving an authentication function call from an application running on a first computing device;
transmitting an invitation request to a second computing device to join the application based on receiving an invitation function call from the first computing device;
transmitting a session identification to the first computing device and second computing device based on transmitting the invitation request to the second computing device;
receiving an event post function call from the first computing device, the event post function call including a change to the application on the first computing device;
receiving an event fetch function call from the second computing device; and
based on receiving the event fetch function call, transmitting the change to the application to the second computing device.
